(19) United States
(12) Patent Application Publication
(10) Pub. No.: US 2006/0166123 A1
(43) Pub. Date: Jul. 27, 2006

(54) Toner, toner container, and toner feeding device and image forming apparatus using the toner container

(76) Inventor: Minoru Masuda, Numazu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/336,909

(22) Filed: Jan. 23, 2006

(30) Foreign Application Priority Data
Jan. 25, 2005 (JP) 2005-016440

(51) Int. Cl. G03G 15/08

(52) U.S. Cl. 430/111.4; 399/258; 430/137.18

(57) ABSTRACT

A toner is provided having binder resin and colorant, wherein the toner satisfies the following relationship T<−0.05ε+0.032 wherein ε represents a void ratio of a bulk toner formed by consolidating the toner with a load of 500 to 3000 N/m², and T represents a torque (Nm) needed for intruding a cone rotor having a vertical angle of 60°, an edge length of 30 mm, and ditches which gradually deepen from vertex to base, into the bulk toner at a speed of 5 mm/min while rotating the cone rotor, wherein the torque is measured when the cone rotor is intruded into the bulk toner at a length of 20 mm; and a toner container, a toner feeding device and an image forming apparatus including the toner.

### BACKGROUND OF THE INVENTION

1. Field of the Invention

The present invention relates to a toner for use in electrophotographic image forming apparatus, such as copiers, facsimile machines and printers. In addition, the present invention also relates to a toner container, and a toner feeding device and an image forming apparatus using the toner container.

2. Discussion of the Background

In the electrophotography, an image is formed as follows:
(1) a photoreceptor serving as a image bearing member is charged uniformly by a charging device;
(2) the photoreceptor is exposed to an image wise light to form an electrostatic latent image thereon;
(3) the electrostatic latent image is visualized to a toner image by adhering a toner in a developing device; and
(4) the toner image is transferred to a paper or an intermediate transfer medium.
   After the toner image is transferred, the toner particles remaining on the photoreceptor are removed by a cleaning device. The photoreceptor is used repeatedly.

Toners conventionally used in electrophotography are manufactured as follows:
(1) colorants such as dyes, pigments and carbon black are dispersed in a binder resin such as natural or synthetic polymers; and
(2) the dispersion is pulverized into small particles having a particle diameter of 1 to 30 μm.
   To produce excellent images, the toner is required to have various kinds of properties such as mechanical characteristics (particle diameter, shape, relative density, fluidity, etc.), electric characteristics (electric resistance, dielectric constant, etc.), heat characteristics (softening point, melting point, etc.), optical characteristics, safety, storage stability, etc. Among these characteristics, fluidity of toner is one of the most important characteristics. This is because fluidity of toner is closely related with the feeding stability of the toner fed from a toner container to a developing device, and the collection ability of the toner collected by a cleaning device.

Conventionally, toner containers used for image forming apparatuses cannot be downsized. Therefore, it is troublesome to collect and transport toner containers after use because containers are bulky. In attempting to downsize a container, a technique in that a flexible material whose volume can be reduced by atmospheric pressure is used for the container is proposed. Such a flexible container can feed the toner to the developing device without using an agitator, while being folded to be downsized after use.

However, helical projections and depressions for feeding a toner cannot be formed on the inner surface of such a flexible container. In addition, a toner feeding device such as an agitator cannot be arranged in the flexible container. Therefore, the following problems tend to occur when using the flexible container:
(1) the amount of the fed toner cannot be stabilized;
(2) the toner cannot be fed due to packing of the toner caused when the toner is preserved; and
(3) a large amount of the toner remains unused in the container.

In attempting to solve these problems, published unexamined Japanese patent application No. (hereinafter referred to as JP-A) 2002-006531 discloses a toner feeding method using a toner container which is made of a flexible material and whose volume can be reduced by not less than 60%. The container is filled with a toner including toner particles having a particle diameter of 2.0 to 4.0 μm in an amount of not larger than 16% by number. The toner contained in the container is aspirated by a suction pump to be transported to a developing device of an image forming apparatus. However, in this method, air is fed to the container to fluidize the toner, and therefore the container cannot reduce the volume sufficiently, resulting in remaining of a large amount of the toner in the container. In addition, when the cohesive force of the toner is large, the toner cannot be deformed only by atmospheric pressure, resulting in remaining of a large amount of the toner in the container, even if the amount of the toner particles having a particle diameter of 2.0 to 4.0 μm is small.

As another technique for solving the problems, JP-A 2004-117002discloses a toner having a particular fluidity. The toner fluidity is evaluated by a method using a cone rotor. Specifically, the method is as follows:
(1) the cone rotor is intruded into a toner contained in a container with rotating; and
(2) a torque or a load needed for intruding the cone rotor into the toner contained in the container is measured when the consolidation conditions (i.e., packing conditions) of the toner are changed.

As another technique for solving the problems, JP-A 2004-240100 discloses a toner having a specific fluidity so as to be easily transported in a tube connecting a toner container and a developing device. Specifically, the fluidity of the toner is controlled such that the torque needed for intruding the cone rotor into the toner which is closely packed in a container such that the void ratio is not greater than 0.6, is 0.0001 to 0.0017 N, wherein the intrusion speed of the cone rotor is 5 mm/min, and the intrusion length is 20 mm. However, when such a toner is contained in a flexible (reducible) container, the toner cannot be transformed only by atmospheric pressure, resulting in remaining of a large amount of the toner in the container.

Because of these reasons, a need exists for a toner which does not remain in a reducible container which can be reduced not less than 60% in volume by atmospheric pressure.

### SUMMARY OF THE INVENTION

Accordingly, an object of the present invention is to provide a toner which hardly remain in a reducible container which can be reduced by not less than 60% in volume by atmospheric pressure.

Another object of the present invention is to provide a toner container which can be reduced in volume as the toner is discharged therefrom.

Another object of the present invention is to provide a toner feeding device which can well transport a toner from a toner container to an image forming apparatus.

Another object of the present invention is to provide an image forming apparatus which can produce high quality images.

These and other objects of the present invention, either individually or in combinations thereof, as hereinafter will become more readily apparent can be attained by a toner comprising resin and colorant, wherein the toner satisfies the following relationship (1):
T<−0.05ε+0.032 (1)
wherein ε represents a void ratio of a bulk toner formed by consolidating the toner with a load of 500 to 3000 N/m², and T represents a torque (Nm) needed for intruding a cone rotor having a vertical angle of 60°, an edge length of 30 mm, and ditches which gradually deepen from vertex to base, into the bulk toner at a speed of 5 mm/min while rotating the cone rotor, wherein the torque is measured when the cone rotor is intruded into the bulk toner at a length of 20 mm;
and a toner container, a toner feeding device and an image forming apparatus, using the toner.

### BRIEF DESCRIPTION OF THE DRAWINGS

These and other objects, features and advantages of the present invention will become apparent upon consideration of the following description of the preferred embodiments of the present invention taken in conjunction with the accompanying drawings, wherein:

FIG. 1 is a schematic view illustrating an embodiment of the image forming apparatus of the present invention;

FIG. 2 is a schematic view illustrating the image forming unit of the image forming apparatus illustrated in FIG. 1;

FIG. 3 is a schematic view illustrating an embodiment of the toner feeding device of the present invention;

FIG. 4 is a schematic perspective view illustrating the toner feeding container of the present invention filled with a toner;

FIG. 5 is a schematic elevation view illustrating the toner feeding container of the present invention whose volume is reduced after the toner therein is ejected;

FIG. 6 is a schematic view illustrating an embodiment of a toner evaluation device for evaluating a torque of a toner;

FIGS. 7A and 7B are schematic views illustrating a cone rotor for use in measuring a torque of a toner;

FIGS. 8A and 8B are schematic views for explaining how to determine the shape factors SF-1 and SF-2;

FIGS. 9A-9C are schematic views illustrating a typical particle of the toner of the present invention; and

FIG. 10 is a graph illustrating the relationship between the void ratio of a toner and the torque needed for intruding the cone rotor into the toner.

### DETAILED DESCRIPTION OF THE INVENTION

The present invention relates to a toner comprising resin and colorant, wherein the toner satisfies the following relationship (1):
T<−0.05ε+0.032 (1)
wherein ε represents a void ratio of a bulk toner formed by consolidating the toner with a load of 500 to 3000 N/m², and T represents a torque (Nm) needed for intruding a cone rotor having a vertical angle of 60°, an edge length of 30 mm, and ditches which gradually deepen from vertex to base, into the bulk toner at a speed of 5 mm/min while rotating the cone rotor, wherein the torque is measured when the cone rotor is intruded into the bulk toner at a length of 20 mm.

The toner preferably has the void ratio of 0.5 to 0.6 when the toner is consolidated by a load of 500 to 3000 N/m².

It is preferable that the torque T of the toner is not greater than 0.0004 Nm.

The toner preferably has an average circularity of not less than 0.90.

The toner preferably has a volume average particle diameter (Dv) of3to8 μm and a ratio (Dv/Dn) of the volume average particle diameter (Dv) to a number average particle diameter (Dn) of 1.00 to 1.40.

The toner preferably has shape factors SF-1 of 100 to 180 and SF-2 of 100 to 180.

It is preferable that the toner is manufactured by a dry-pulverization method comprising:

kneading a toner composition comprising the binder resin and the colorant;

pulverizing the kneaded toner composition; and

classifying the pulverized toner composition.

It is also preferable that the toner is manufactured by a wet-polymerization method comprising:

dissolving or dispersing a toner constituent mixture comprising a polymer capable of reacting with an active hydrogen atom, a polyester resin, and the colorant, in an organic solvent to prepare a toner constituent mixture liquid; and

dispersing the toner constituent mixture liquid in an aqueous medium while subjecting the polymer to at least one of an extension reaction or a crosslinking reaction using a compound having an active hydrogen atom, to prepare a dispersion comprising toner particles in the presence of a particulate resin.

It is preferable that the toner further comprising a release agent.

As another aspect of the present invention, a toner container is provided which includes a flexible member containing the toner mentioned above, and an adopter by which the toner container is set to an image forming apparatus, wherein the toner container reduces volume as the toner is discharged therefrom.

As another aspect of the present invention, a toner feeding device is provided which comprises:

the toner container mentioned above; and

a toner feeding member configured to transport the toner from the toner container to an image forming apparatus.

It is preferable that the flexible member of the toner feeding container comprises a resin film, and the volume of the toner container is reduced by not less than 60%.

It is preferable that the toner feeding member comprises a pump configured to feed the toner.

It is preferable that the pump is a mohno pump.

As another aspect of the present invention, an image forming apparatus is provided which comprises:

an image bearing member configured to bear an electrostatic latent image;

a charging device configured to charge the image bearing member;

a writing device configured to irradiate the charged image bearing member with a light beam to form the electrostatic latent image;

a developing device configured to develop the electrostatic latent image with a developer including a toner to form a toner image on the image bearing member;

the toner container mentioned above; and

a toner feeding device configured to feed the toner from the toner container to the developing device.

Next, the image forming apparatus in the present invention will be explained in detail.

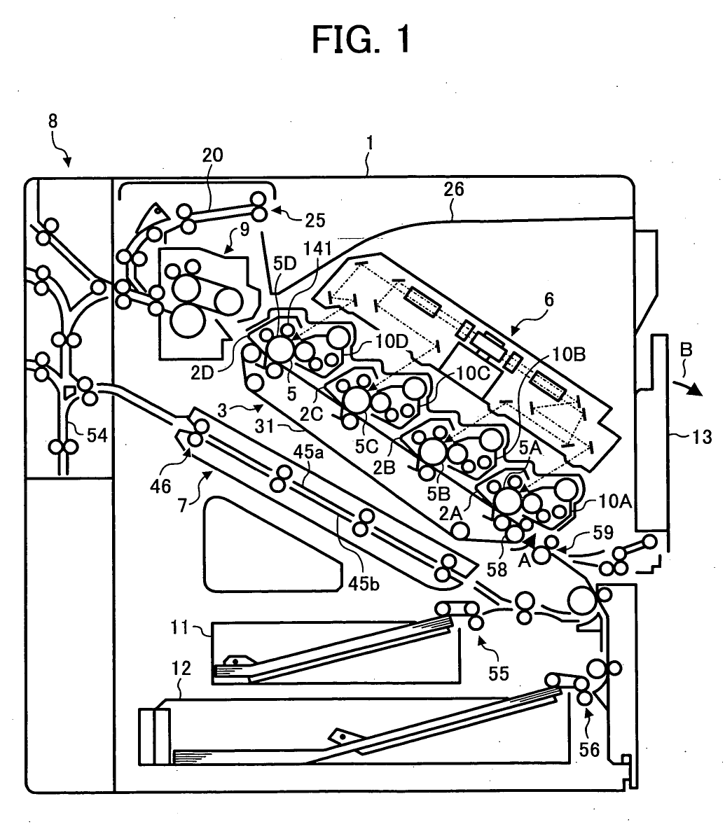

FIG. 1 is a schematic view illustrating an embodiment of the image forming apparatus of the present invention applying to a compact full color printer.

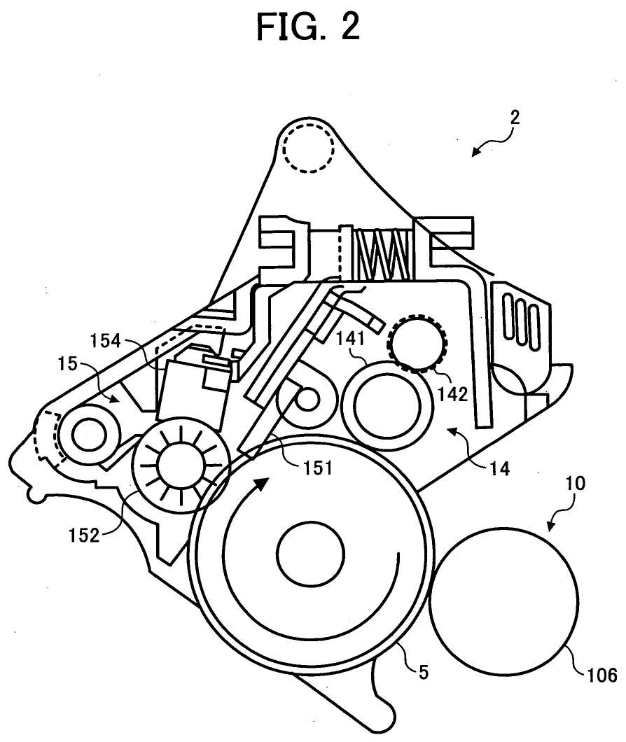

FIG. 2 is a schematic view illustrating an image forming unit of the image forming apparatus illustrated in FIG. 1. The image forming units 2A, 2B, 2C and 2D shown in FIG. 1 have the same configuration, and therefore only one image forming unit is shown in FIG. 2. Symbols A, B, C and D, which represent respective colors, are omitted from the reference number.

Referring to FIG. 1, an image forming apparatus 1 includes four image forming units 2A, 2B, 2C and 2D having respective photoreceptors serving as image bearing members. The image forming units 2A, 2B, 2C and 2D are detachable from the image forming apparatus 1 respectively. A transfer device 3 is arranged in the center of the image forming apparatus 1. The transfer device 3 includes a transfer belt 31 tightly stretched by plural rollers to rotate endlessly in the direction indicated by an arrow A.

The upper surface of the transfer belt 31 contacts with photoreceptors 5A, 5B, 5C and 5D included in the image forming units 2A, 2B, 2C and 2D respectively. The developing devices 10A, 10B, 10C and 10D using different color toners are arranged so as to face the image forming units 2A, 2B, 2C and 2D respectively.

The image forming units 2A, 2B, 2C and 2D have the same configuration. The image forming units 2A, 2B, 2C and 2D form magenta image, cyan image, yellow image and black image, respectively.

Referring to FIG. 2, the image forming unit 2 includes the photoreceptor 5 configured to bear an electrostatic latent image thereon, a charging device 14 configured to charge the surface of the photoreceptor 5, and a cleaning device 15 configured to clean the surface of the photoreceptor 5.

Specific examples of the photosensitive materials used for the photoreceptor 5 include amorphous metals such as amorphous silicon and amorphous selenium, and organic compounds such as bisazo dyes and phthalocyanine pigments. From the viewpoint of the environmental protection (i.e., disposal after use), organic compounds are preferably used.

Suitable charging methods for use in the charging device 14 include corona charging methods, roller charging methods, brush charging methods, and blade charging methods. The charging device 14 shown in FIG. 2 uses a roller charging method. The charging device 14 includes a charging roller 141, a cleaning brush 142 configured to clean the charging roller 141, an electric source (not shown) connected to the charging roller 141. A high voltage is applied to the charging roller 141 to uniformly charge the surface of the photoreceptor 5.

The cleaning device 15 includes a cleaning blade 151 configured to contact with the photoreceptor 5 to scrape off residual toner particles thereon, and a lubricant applying member 152 which is configured to scratch off a solid lubricant 154 to apply the lubricant to the photoreceptor 5 and which is located on a upstream side of from the cleaning blade 151 relative to the rotating direction of the photoreceptor 5. The lubricant applying member 152 also has a function of removing the residual toner on the photoreceptor 5. After the primary transfer process, the residual toner remaining on the photoreceptor 5 is removed by the lubricant applying member 152. Subsequently, the lubricant applying member 152 applies particles of the solid lubricant 154 to the photoreceptor 5. Finally, the residual toner and the film remaining on the photoreceptor 5 are removed by the cleaning blade 151.

Referring to FIG. 1, a writing unit 6 is arranged above the image forming units 2A, 2B, 2C and 2D. A duplex unit 7 is arranged below the image forming units 2A, 2B, 2C and 2D. The image forming apparatus 1 includes a reverse unit 8 on the left side of the image forming apparatus. The reverse unit 8 reverses a transfer paper having an image thereon, and ejects or transports the transfer paper to the duplex unit 7.

The writing unit 6 includes four laser-diode-type light sources for respective color images; a polygon scanner including a hexagonal polygon mirror and a polygon motor; lenses such as fθ lenses arranged on optical paths of respective light sources and long cylindrical lenses; and mirrors. A laser light emitted by the laser diode is deflected and scanned by the polygon scanner to irradiate the photoreceptors 5A, 5B, 5C and 5D.

The duplex unit 7 includes a pair of transport guides 45a and 45b, and plural pairs of transport rollers 46. In the duplex image forming mode, i.e., when images are formed on both sides of the transfer paper, at first, the transfer paper having an image on one side thereof is transported to a reverse/transport path 54 in the reverse unit 8 to be switchback-transported. Then the transfer paper is received by the duplex unit 7 to be transported to a paper feeding part.

The reverse unit 8 includes plural pairs of transport rollers and plural pairs of transport guides. As mentioned above, the reverse unit 8 has the following functions:
(1) reversing the transfer paper to feed the paper to the duplex unit 7 when duplex imaging is performed;
(2) discharging the transfer paper from the machine without reversing the paper; and
(3) reversing the transfer paper and discharging the paper from the machine.
   The paper feeding part includes paper feeding cassettes 11 and 12 including respective paper separating/feeding parts 55 and 56 which separate and feed the transfer paper.

A fixing device 9 is arranged between the transfer belt 31 and the reverse unit 8. The fixing device 9 fixes the images transferred onto the transfer paper. A paper reverse/ejection path 20 which is branched is formed on a downstream side from the fixing device 9 relative to the paper feeding direction. The transfer paper transported to the paper reverse/ejection path 20 is fed to a catch tray 26 by a pair of paper feeding rollers 25.

The paper feeding cassettes 11 and 12 are arranged in a lower part of the image forming apparatus 1. Two-tiered paper feeding cassettes 11 and 12 can contain different-size papers respectively. On the right side of the image forming apparatus 1, a manual feed tray 13 is arranged, which can be opened and closed in the direction indicated by an arrow B. When the manual feed tray 13 is opened, the paper can be fed manually.

Then the operation of the image forming apparatus in the image forming process will be explained. At first, photoreceptors 5A, 5B, 5C and 5D start rotating in a clockwise direction respectively. The surface of each photoreceptor is charged uniformly by the charging roller 141. The photoreceptors 5A, 5B, 5C and 5D in the respective image forming unit 2A, 2B, 2C and 2D are irradiated according to image data by laser lights emitted by the writing unit 6 to form electrostatic latent images corresponding to magenta, cyan, yellow and black color images respectively, to form electrostatic latent images on the photoreceptors. The photoreceptors 5A, 5B, 5C and 5D rotate to transport the electrostatic latent images to the respective developing devices 10A, 10B, 10C and 10D so that the latent images are developed by a magenta toner, a cyan toner, a yellow toner and a black toner respectively. Thus, four-color toner images are formed.

On the other hand, the transfer paper contained in paper feeding cassettes 11 and 12 is fed from the paper separating/feeding part by a pair of registration rollers 59 arranged immediately before the transfer belt 31. The transfer paper is timely fed to meet the toner images on the photoreceptors 5A, 5B, 5C and 5D. The transfer paper is charged positively by a paper attraction roller 58 arranged near the entrance of the transfer belt 31 to be electrostatically attracted to the surface of the transfer belt 31. The transfer paper attracted to the transfer belt 31 is transported such that magenta, cyan, yellow and black images are transferred thereon sequentially. Thus four color toner images are superimposed on the transfer paper, resulting in formation of a full-color toner image. The toner image on the transfer paper is fixed by the fixing device 9 upon application of heat and pressure. Subsequently, the transfer paper is transported to one of paper ejection paths depending on the selected image forming mode. The paper ejection paths are as follows:
1) the paper is reversed and fed to the catch tray 26 formed on the upper surface of the image forming apparatus 1;
2) the paper is transported straight ahead from the fixing device 9 to the reverse unit 8 and then ejected; and
3) the paper is transported to the reverse/transport path in the reverse unit 8 to be swtitchback-transported to the duplex unit 7, and is then fed again to the image forming units 2A, 2B, 2C and 2D so that the images are formed on the backside of the paper.

On the other hand, the photoreceptors 5A, 5B, 5C and 5D separated from the transfer belt 31 continue to rotate. Referring to FIG. 2, the brush roller 152 serving as a lubricant applying member scratches off the solid lubricant 154 and applies the lubricant to the photoreceptor 5.

The image forming process mentioned above is repeated. Because the lubricant layer formed on the photoreceptor 5 is very thin, charging of the photoreceptor by the charging device 14 is not obstructed thereby. A toner image formed again on the surface (i.e., the lubricant layer) of the photoreceptor 5 is transferred onto the transfer paper attracted to the transfer belt 31.

The developing device 10 includes a developing roller 106 facing the photoreceptor 5, a screw configured to transport and agitate a developer, a toner concentration sensor, etc. The developing roller 106 includes a rotatable sleeve outside and a fixed magnet inside. In response to the output from the toner concentration sensor, the toner is fed from a toner feeding device. In the present example, two-component developer including a toner and a carrier is used.

The carrier consists of a core material itself or a core material having a coating layer thereon. Specific examples of the core material include ferrite and magnetite. The particle diameter of the core material is 20 to 65 μm, and preferably 30 to 60 μm. Specific examples of the resin used for the coating layer include styrene resins, acryl resins, fluorocarbon resins, silicon resins and mixtures and copolymers of these resins. Suitable coating methods include known coating methods such as spray coating and dip coating.

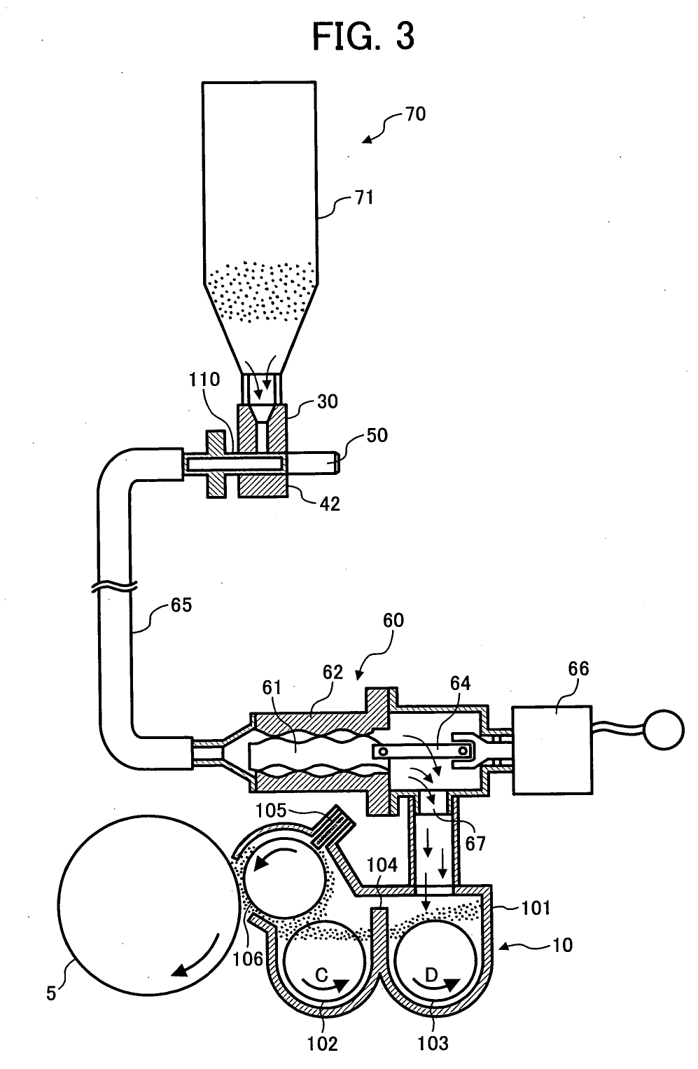

FIG. 3 is a schematic view illustrating an embodiment of the toner feeding device of the present invention which supplies the toner to the developing device.

The developing device 10 includes a casing 101 including screws 102 and 103 having spiral fins called a transport auger, rotating in the direction indicated by arrows C and D respectively. The casing 101 contains the developer including the toner of the present invention and a carrier. The screw 102 transports the developer in the direction of from the front side to the back side of the figure by the transport auger. In contrast, the screw 103 transports the developer in the direction of from the back side to the front side of the figure by the transport auger. The developer is agitated by being circulated through cut portions of a divider 104, which are formed on both end portions of the divider. A part of the circulated developer is drawn up by a developing roller 106 thereon due to the magnetic force. After the thickness of the developer drawn up to the developing roller 106 is controlled by a doctor blade 105, the developer contacts with the photoreceptor 5 to develop the electrostatic latent image thereon with the toner. Because only the toner is adhered to the photoreceptor 5, the toner is supplied from a toner supply opening 67 to keep the toner concentration constant in the developer circulating in the developing device 10.

The toner feeding device includes a toner feeding container 70 configured to contain a new toner; and mohno pump 60 configured to suck the toner from the toner feeding container 70 to supply the toner to the toner supply opening 67.

The toner feeding container 70 includes a flexible bursiform toner container 71 configured to contain the toner, and a pump adapter 30 connected to the lowermost part of the toner container 71. A nozzle 110 is inserted to the pump adapter 30 for aspiration. A shutter 50 is configured to prevent an outflow of the toner when the nozzle 110 is not inserted. A sealing material 42 is arranged on both sides of the nozzle 110 or the shutter 50 to improve the hermeticity.

The mohno pump 60 is connected to the nozzle 110 via a tube 65. The mohno pump shown in FIG. 3 is a single-shaft decentered screw pump. A rotor 61 and a stator 62 are main parts of the pump. The rotor 61 is made of a hard material, and has a shape such that a cylinder having a circular-section is spirally twisted. The stator 62 is made of a rubbery soft material, and has a hole which has an oval-section and which is spirally twisted. The spiral pitch of the stator 62 is twice that of the rotor 61. The rotor 61 is engaged with the stator 62. The toner contained in the space formed between the rotor 61 and the stator 62 is transported by the rotation of the rotor 61. A motor 66 configured to rotate the rotor 61 is connected to the rotor 61 via a universal joint 64. The toner is aspirated and transported from the left side to the right side of FIG. 3 and the toner then falls down from the toner supply opening 67 to the developing device 10. The nozzle 110 the mohno pump 60 and the developing device 10 are fixed to the image forming apparatus 1. The toner feeding container 70 is changed to a new one whenever the toner therein is exhausted. Whenever the toner feeding container 70 is changed, connection and disconnection of the nozzle 110 is performed. In this case, the hermeticity between the pump adapter 30 and the nozzle 110 is very important to prevent occurrence of contamination and air leakage of the toner feeding device.

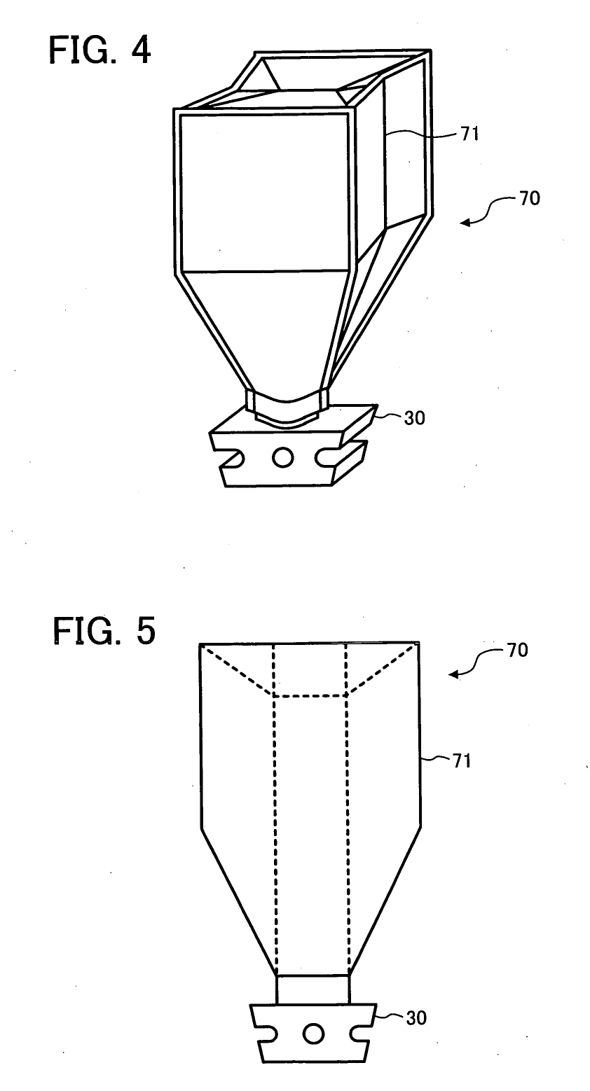

FIG. 4 is a schematic perspective view illustrating the toner feeding container for use in the toner feeding device of the present invention, which is filled with the toner of the present invention.

FIG. 5 is a schematic elevation view illustrating the toner feeding container for use in the toner feeding device of the present invention when the volume is reduced after the toner is discharged.

The volume of toner container 71 is preferably reduced by not less than 60%. The toner container 71 is made of a bilayer sheet including an inner layer made of polyethylene and an outer layer made of nylon. To improve the strength of the sheet, an outermost layer made of aluminum or PET (polyethylene terephthalate) can be formed. The thickness of the sheet is 50 to 210 μm.

The flexible toner container 71 is reduced in volume by atmospheric pressure when the toner is ejected. The toner contained in the toner feeding container 70 is compressed to some extent because agitation is not performed in the container. (In this regard, the compressed toner is called a bulk toner.) A toner having low fluidity tends to remain in the toner feeding container in a large amount. Therefore, the bulk toner in the toner feeding container needs to be transformed by atmospheric pressure when the toner is ejected. The transformation of the bulk toner is caused by the friction generated between the toner particles. The friction of toner can be determined by the rotational torque.

According to our examination, a bulk toner in a container can transform when the following relationship (1) is satisfied:
T<−0.05ε+0.032 (1)
wherein ε represents a void ratio of a bulk toner formed by consolidating the toner with a load of 500 to 3000 N/M² and T represents a torque (Nm) needed for intruding a cone rotor having a vertical angle of 60°, an edge length of 30 mm, and ditches which gradually deepen from vertex to base, into the bulk toner at a speed of 5 mm/min while rotating the cone rotor, wherein the torque is measured when the cone rotor is intruded into the bulk toner at a length of 20 mm.

When the toner is consolidated by a strong pressure, the void ratio ε is small. Therefore a large stress is needed for transforming the bulk toner. In contrast, when the toner is consolidated by a week pressure, the void ratio ε is large. Therefore a small stress is needed for transforming the bulk toner.

The toner in the present invention has a small torque so as to satisfy the relationship (1). In order to decrease the torque T, i.e., to decrease the frictional force between the toner particles, the following method can be used.

Specifically, the frictional force can be decreased by controlling the toner surface nature, the toner shape, and the toner particle diameter distribution. With respect to the toner surface nature, the frictional force can be decreased by reducing the amount of soft and cohesive materials such as waxes existing on the surface of the toner particles, or adding a large amount of highly hydrophobic external additives to the toner particles. With respect to the toner shape, the frictional force increases when the toner has an irregular surface and thereby the toner particles are strongly adhered to each other. In general, a spherical toner has a low frictional force. With respect to the toner particle diameter, the frictional force increases as the particle diameter decreases because the surface area of the toner increases.

The method for evaluating the torque T is as follows:
(1) intruding (pushing down) a cone rotor into a bulk toner or drawing (pulling) up the cone rotor from the toner phase;
(2) measuring a torque when the cone rotor intrudes into the bulk toner; and
(3) determining the fluidity of the toner from the torque.

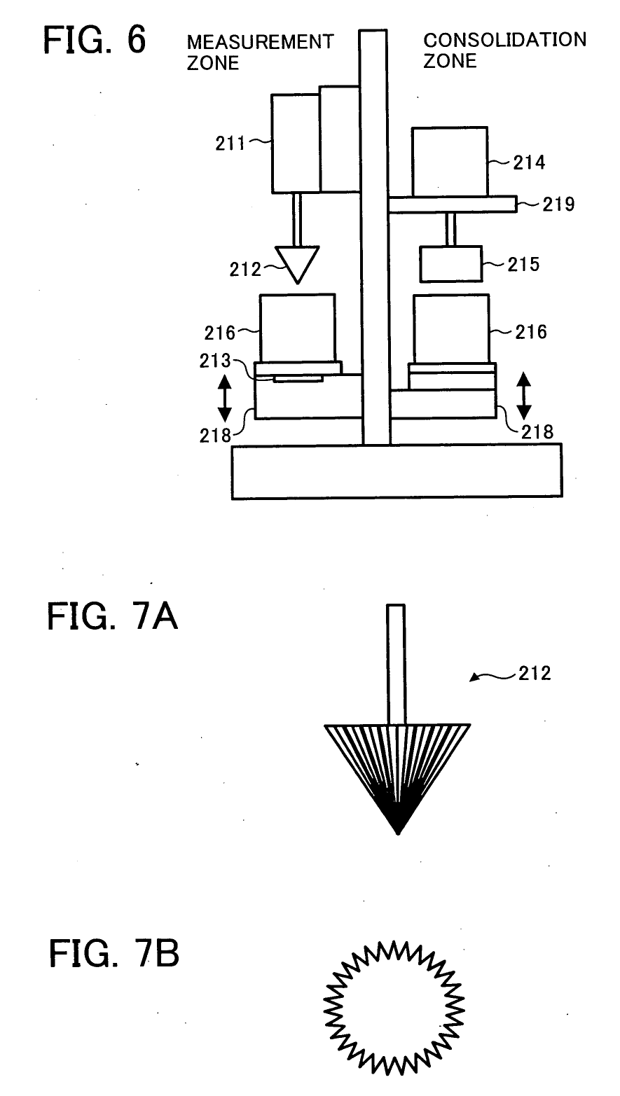

FIG. 6 is a schematic view illustrating an embodiment of the toner evaluation device of the present invention. The toner evaluation device includes a consolidation zone and a measurement zone. However, the toner evaluation device of the present invention is not limited thereto.

The consolidation zone includes a container 216 configured to contain a toner, an elevating stage 218 configured to lifting or lowering the container 216 a piston 215 configured to consolidate the toner, and a weight 214 configured to apply a load to the piston 215.

The container 216 filled with the toner is lifted so that the toner contacts the piston 215. Subsequently, the container 216 is further lifted so that all the weight of the weight 214 is applied to the piston 215. Namely, the weight 214 is supported only by the piston 215 while separated from a supported board 219. After being left for a predetermined time, the container 216 is detached from the piston 215 by lowering the elevating stage 218.

The piston 215 is made of a material having a smooth surface to consolidate the sample. Processible, hard and non transmutable materials are preferably used for the piston 215. In addition, in order to prevent an electric adherence of the toner to the piston, electroconductive materials are preferably used therefore. Specific examples of the materials for use in the piston include SUS, Al, Cu, Au, Ag, brass, etc., but are not limited thereto.

In the present invention, the container 216 has an internal diameter φ of 60 mm and a height of the consolidated toner of 25 to 28 mm.

The measurement zone includes the container 216 configured to contain the toner, the elevating stage 218 configured to lifting or lowering the container 216 a load cell 211 configured to measure a load, and a torque meter 213 configured to measure a torque.

A cone rotor 212 is set to the tip of a shaft, and the shaft is fixed not to move up and down.

The container 216 filled with the toner is set on the center of the elevating stage 218. The container 216 is lifted so that the cone rotor 212 intrudes into the center of the container 216 while rotating.

The torque applied to the cone rotor 212 is detected by the torque meter 211 arranged on the upper side thereof, the load applied to the container 216 is detected by the load cell 213 arranged on the lower side thereof, and the intrusion distance of the cone rotor 212 is detected by a position detector.

FIG. 7A is a schematic view illustrating the cone rotor for use in the evaluation device. The cone rotor 212 has a vertical angle of 60°. Ditches are formed straightly from the vertex to the base of the cone part as shown in FIG. 7A. FIG. 7B is a cross section of the cone rotor 212. The cross section of the ditches has a saw tooth shape. The cone rotor has an edge length of 30 mm. The depth of the ditches at the vertex is 0 mm, while the depth is 1 mm at the base. The ditches gradually deepen from the vertex to the base. The number of the ditches is forty-eight.

In this evaluation device, the frictional force between the toner particles is measured, instead of the frictional force between the surface of the cone rotor 212 and the toner particles.

Specifically, the toner particles are contact with the surface of the cone rotor 212 only at the peaks of the ditches of the cone rotor 212. Most of the toner particles contact with the toner particles present in the valleys of the ditches.

Processible, hard and non transmutable materials are preferably used for the cone rotor 212. In addition, electroconductive materials are preferably used. Specific examples of the suitable materials include SUS, Al, Cu, Au, Ag, brass, etc., but are not limited thereto.

In the present invention, the toner evaluation conditions are as follows:
rotation speed of the cone rotor: 1 rpm
intrusion speed of the cone rotor: 5 mm/min
intrusion length of the cone rotor: 20 mm

The material used for the container 216 is not particularly limited, however, electroconductive materials are preferably used in order that the container is not influenced by the toner charge. In addition, materials having mirror surfaces are preferably used to prevent the contamination, because the toners are measured one after another.

As the torque meter 211 a high sensitive and a noncontact-type torque meter is preferably used. As the load cell 213 a load cell having a wide loading range and a high resolution is preferably used. As the position detector, linear scale position detectors and displacement sensors using light can be used. A position detector having a precision of not greater than 0.1 mm is preferably used for the evaluation device. As the elevator, servomotors and stepping motors are preferably used because of driving accurately.

Next, the measurement method will be explained in detail.

At first, the container 216 is filled with a predetermined amount of a toner, and is then set to the toner evaluation device. The cone rotor 212 is intruded into the bulk toner while rotating.

However, it is preferable that the toner is pressed to be consolidated before the cone rotor 212 is intruded therein. When the torque and the load are measured, the rotation speed and the intrusion speed are fixed.

The rotational direction of the cone rotor 212 is not limited. When the intrusion length of the cone rotor 212 is small, the reproducibility of the data deteriorates because the measured torques and loads are too small. In order to obtain highly reproducible data, the intrusion length is preferably lengthened to some extent. In the present invention, stable measurement can be attained when the intrusion length is not less than 5 mm and preferably 20 mm. Specifically, the measurement method is preferably as follows:
(1) the container 216 is filled with a toner;
(2) the toner is compressed to achieve a consolidation state;
(3) the cone rotor 212 is intruded into the toner with rotating, and the torque and the load are measured;
(4) the cone rotor 212 is stopped to intrude at a predetermined point having a certain depth (20 mm) from the surface of the toner surface;
(5) the cone rotor 212 starts to be pulled up; and
(6) when the cone rotor 212 is completely pulled up from the toner and become free (is returned to the initial home position), the movement of the cone rotor 212 is stopped.

The above-mentioned method is repeated. The measurement can be performed continuously.

Then the void ratio will be explained in detail. The void ratio ε is defined by the following formula (2):
ε=(V−M/ρ)/V (2)
wherein ε represents the void ratio, M represents the weight of the toner contained in the container, ρ represents the absolute specific gravity of the toner and V represents the volume of the toner layer.

The absolute specific gravity of the toner is measured by AIR COMPARISON PYCNOMETER MODEL 930 manufactured by Beckman Instruments Inc.

The toner for use in the present invention preferably has a volume average particle diameter (Dv) of not greater than 8 mm from the viewpoint of the thin line reproducibility of the produced image, and is not less than 3 mm from the viewpoint of the developing ability and the cleanability. When the volume average particle diameter (Dv) is too small, the toner particles having an extremely small diameter tend to exist on the surfaces of carriers and a developing roller. Therefore, the other toner particles cannot be sufficiently frictionized by the carrier and the developing roller, resulting in formation of the reversely-charged toner particles. In this case, abnormal images such as background development are produced.

The toner for use in the present invention preferably has a particle diameter distribution (Dv/Dn), i.e., a ratio of the volume average particle diameter (Dv) to a number average particle diameter (Dn), of 1.05 to 1.40. When the toner has such a sharp particle diameter distribution, the toner can be charged uniformly. When the ratio (Dv/Dn) is too large, the toner has a broad charge quantity distribution and the resultant images have poor resolution. The toner having too small the ratio (Dv/Dn) has a difficulty in manufacturing. The volume average particle diameter (Dv) and number average particle diameter (Dn) can be measured using an instrument COULTER COUNTER MULTISIZER from Coulter Electrons Inc. An aperture having a diameter of 50 μm is used according to the toner particle diameter. The volume average particle diameter (Dv) and number average particle diameter (Dn) is determined by calculating the average data of 50,000 toner particles in number.

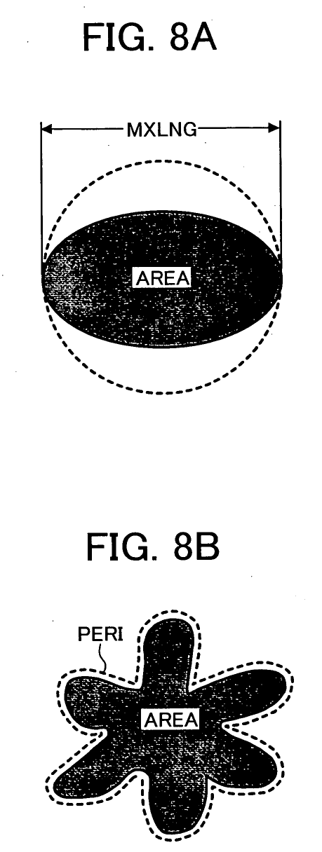

The toner for use in the present invention preferably has a shape factor SF-1 of 100 to 180 and another shape factor SF-2 of 100 to 180. FIGS. 8A and 8B are schematic views for explaining the shape factors SF-1 and SF-2 respectively.

As illustrated in FIG. 8A, the shape factor SF-1 represents the degree of the roundness of a toner particle, and is defined by the following equation (3):
SF-1={(MXLNG)²/(AREA)}×(100π/4) (3)
wherein MXLNG represents a diameter of the circle circumscribing the image of a toner particle, which image is obtained by observing the toner particle with a microscope; and AREA represents the area of the image.

When the SF-1 is 100 , the toner particle has a true spherical form. When the SF-1 is larger than 100 the toner particles have irregular forms.

As illustrated in FIG. 8B, the shape factor SF-2 represents the degree of the concavity and convexity of a toner particle, and is defined by the following equation (4):
SF-2={(PERI)²/(AREA)}×(100π/4) (4)
wherein PERI represents the peripheral length of the image of a toner particle observed by a microscope; and AREA represents the area of the image.

When the SF-2 approaches 100 the toner particles have a smooth surface (i.e., the toner has few concavity and convexity) When the SF-2 is large, the toner particles are roughened.

The shape factors SF-1 and SF-2 are determined by the following method:
(1) particles of a toner are photographed using a scanning electron microscope (S-800 manufactured by Hitachi Ltd.); and
(2) photograph images of toner particles are analyzed using an image analyzer (LUZEX 3 manufactured by Nireco Corp.) to determine the SF-1 and SF-2.

When the toner particles have spherical form, the toner particles contact the other toner particles and the photoreceptor at one point. Therefore, the adhesion of the toner particles to the other toner particles and the photoreceptor decreases, resulting in increase of the fluidity of the toner particles and the transferability of the toner. In addition, the residual toner on the photoreceptor can be removed easily.

The toner for use in the present invention preferably has the SF-1 and SF-2 of not less than 100 respectively. However, when the SF-1 and SF-2 are too large, the toner particles have irregular forms and thereby the toner has a broad charge quantity distribution, poor developability and poor transferability, resulting in deterioration of the image qualities. Moreover, a large amount of the toner particles remain on the photoreceptor because of poor transferability, and a large cleaning device 15 being disadvantage of downsizing the image forming apparatus has to be arranged. Therefore, the SF-1 and SF-2 are preferably not larger than 180 respectively.

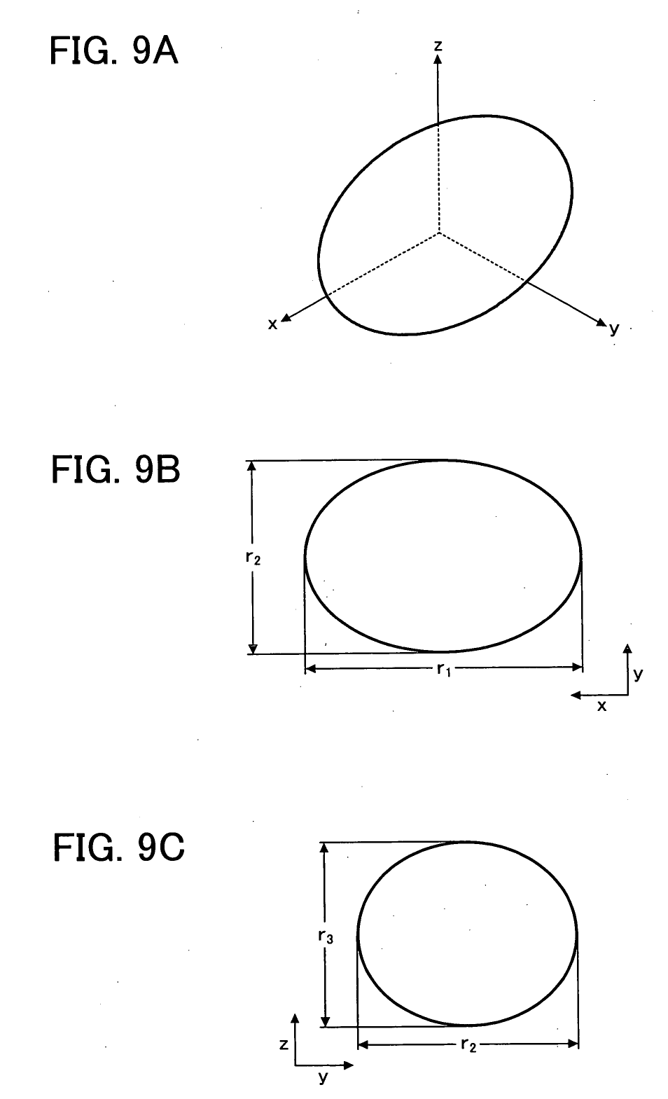

The toner for use in the present invention preferably has a form similar to the spherical form. FIG. 9A is an external view of the toner, and FIGS. 9B and 9C are cross sections of the toner. The toner preferably satisfies the following relationship:
0.5≦(r2/r1)≦1.0 and 0.7≦(r3/r2)≦1.0
wherein r1, r2 and r3 represent the average major axis particle diameter, the average minor axis particle diameter and the average thickness of particles of the toner, wherein r3≦r2≦r1.

When the ratio (r2/r1) is too small, the toner has a form far away from the spherical form, and therefore the toner has a broad charge quantity distribution. When the ratio (r3/r2) is too small, the toner has a form far away from the spherical form, and therefore the toner has a broad charge quantity distribution. When the ratio (r3/r2) is 1.0 the toner has a form similar to the spherical form, and therefore the toner has a narrow charge quantity distribution.

The above-mentioned size factors (i.e., r1, r2 and r3) of toner particles can be determined by observing the toner particles with a scanning electron microscope while the viewing angle is changed.

The toner shape can be controlled in toner manufacturing methods. A pulverized toner having a rough surface and an irregular form can alter the shape into a nearly spherical from by applying mechanical or thermal treatments thereto. A toner manufactured by methods forming droplets in the water such as the suspension polymerization method and the emulsion polymerization method tends to have a smooth surface and a nearly spherical shape. In addition, the toner mentioned above can alter the shape into a spindle form by agitating and applying a high shear in the reaction process.

The toner having a form similar to the spherical form is preferably manufactured by a method as follows:
(1) a polyester prepolymer having a nitrogen atom, a polyester, a colorant and a release agent are dissolved or dispersed in a organic solvent to prepare a toner constituent mixture liquid; and
(2) dispersing the toner constituent mixture liquid in an aqueous medium while subjecting the polymer to at least one of an extension reaction and a cross linking reaction.

Then the materials used for the toner and the manufacturing method of the toner will be explained below.

<Resin>

Specific examples of the resins include polystyrene resins, epoxy resins, polyester resins, polyamide resins, styrene acryl resins, styrene methacrylate resins, polyurethane resins, vinyl resins, polyolefin resins, styrene butadiene resins, phenol resins, polyethylene resins, silicon resins, butyral resins, terpen resins, polyol resins, etc.

Specific examples of the vinyl resins include monopolymers of styrene and derivative substitute such as polystyrene, poly-p-chlorostyrene and polyvinyltoluene; copolymers of styrene such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-α-chloro methyl methacrylate copolymers, styrene-acrylonitrile copolymers, styrene-vinyl methyl ether copolymers, styrene-vinyl ethyl ether copolymers, styrene-vinyl methyl ketone copolymers, styrene-butadiene copolymers, styrene-isoprene copolymers, styrene-acrylonitrile-indene copolymers, styrene-maleic acid copolymers and styrene-maleate copolymers; polymethylmethacrylate, polybutylmethacrylate, polyvinylchloride, polyvinylacetate, etc.

Specific examples of the polyester resins are formed by the reaction between diols (A group) and dibasic acids (B group), optionally adding polyols and polycarboxylic acids (C group) having three or more valences. Specific examples of the compounds of A group, B group and C group are shown as follows:
A group: ethylene glycol, triethylene glycol, 1,2-propione glycol, 1,3-propione glycol, 1,4-butanediol, neopentyl glycol, 1,4-buenediol, 1,4-bis(hydroxymethyl)cyclohexane, bisphenol A, hydrogenated bisphenol A, polyoxyethilenic bisphenol A, polyoxypropylene(2,2)-2,2′-bis(4-hydroxyphenyl)propane, polyoxypropylene(3,3)-2,2-bis(4-hydroxyphenyl)propane, polyoxyethylene(2,0)-2,2-bis(4-hydroxyphenyl)propane, polyoxypropylene(2,0)-2,2′-bis(4-hydroxyphenyl) propane, etc.;
B group: maleic acid, fumaric acid, mesaconic acid, citraconic acid, itaconic acid, glutaconic acid, phthalic acid, isophthalic acid, terephthalic acid, cyclohexanedicaboxylic acid, succinic acid, adipic acid, sebacic acid, malonic acid, linolenic acid, anhydrides or lower alcohol esters of these compounds,. etc.; and
C group: polyols having three valences or more such as glycerine, trimethylolpropane and pentaerythrithol; poly carboxylic acids having three valences or more such as trimellitic acid and pyromellitic acid.

Specific examples of the polyol resins are formed by the reactions between epoxy resins, alkylene oxide adducts or glycidyl ethers of bisphenols, compounds having one active hydrogen reacting to the epoxy group, and compounds having two or more active hydrogen reacting to the epoxy group.

<Colorant>

Specific examples of black colorants for use in the present invention include azine colorants such as carbon black, oil farness black, channel black, lamp black, acethylene black, aniline black; metal salts azo pigments, metal oxides, composite metal oxides, etc.

Specific examples of yellow colorants for use in the present invention include Cadmium Yellow, Mineral Fast Yellow, Nickel Titanium Yellow, Naples Yellow, NAPHTHOL YELLOW S, HANSA YELLOW G, HANSA YELLOW 10G, BENZIDINE YELLOW GR, QUINOLINE YELLOW LAKE, PERMANENT YELLOW NCG, Tartrazine Lake, etc.

Specific examples of orange colorants for use in the present invention include molybdenum orange, PERMANENT ORANGE GTR, pyrazolone orange, Vulcan Orange, INDANTHRENE BRILLIANT ORANGE GTR, BENZIDINE ORANGE G, INDANTHRENE BRILLIANT ORANGE GK.

Specific examples of red colorants for use in the present invention include colcothar, cadmium red, PERMANENT RED 4R, Lithol Red, pyrazolone red, watching red calcium salt, Lake Red D, BRILLIANT CARMINE 6B, Eosin Lake, Rhodamine lake B, Alizarine Lake, BRILLIANT CARMINE 3B, etc.

Specific examples of violet colorants for use in the present invention include Fast Violet B, Methyl Violet Lake, etc.

Specific examples of blue colorants for use in the present invention include cobalt blue, alkali blue, Victoria Blue Lake, Phthalocyanine Blue, metal-free Phthalocyanine Blue, Phthalocyanine Blue chloride, Fast Sky Blue, INDANTHRENE BLUE BC, etc.

Specific examples of green colorants for use in the present invention include Chrome Green, chrome oxide, Pigment Green B, Malachite Green Lake, etc.

These pigments can be used alone or in combination.

In particular, the colorants preferably used as a master batch pigment to be dispersed in the resin uniformly.

<Charge Controlling Agent>

The toner of the present invention includes a charge controlling agent which is included in the toner particles and/or is externally added to the toner particles. By using a proper charge controlling agent and controlling the added amount, the charge of the toner can be optimized for a target developing system. In the toner of the present invention, the toner particle diameter and the charge level are well balanced, so that excellent images can be produced.

Specific examples of positive charge controlling agents include nigrosine dyes, quaternary ammonium salts, triphenylmethane dyes, imidazolmethal complexes and salts, etc. Specific examples of negative charge controlling agents include salycilic acid metal complexes and salts, organic boron salts, calixarene, etc. These can be used alone or in combination.

<Release Agent>

The toner of the present invention optionally includes a release agent to have a good hot offset resistance. Specific examples of the releasing agents include natural waxes such as candelilla waxes, carnauba waxes, rice waxes; montan waxes and their derivatives, paraffin waxes and their derivatives, polyolefin waxes and their derivatives, SASOL waxes, low-molecular-weight polyethylene, low-molecular-weight polypropylene, alkylphosphate ester, etc. These waxes preferably have the melting point of 65 to 90° C. When the melting point of the wax used is too low, the preservability of the resultant toner deteriorates. In contrast, when the melting point is too high, the resultant toner tends to cause a cold offset problem in that a toner image adheres to a fixing roller when the toner image is fixed at a relatively low fixing temperature.

<Internal Additive>

The toner of the present invention optionally includes an internal additive to improve the dispersibility of the releasing agent, etc. Specific examples of the internal additives include styrene-acrylic resins, polyethylene resins, polystyrene resins, epoxy resins, polyester resins, polyamide resins, styrene methacrylate resins, polyurethane resins, vinyl resins, polyolefin resins, styrene butadiene resins, phenol resins, butyral resins, terpene resins, polyol resins, etc. These resins are used alone or in combination.

The toner for use in the present invention can be prepared by a method such as pulverization methods and polymerization methods (such as suspension polymerization, emulsion polymerization, dispersion polymerization, emulsion aggregation and emulsion association methods) but is not limited thereto.

The surface of the mother toner particles of the present invention can be modified by small particles relative to the toner mother particles. Particulate organic or inorganic materials having a particle diameter of not greater than tenth of that of the toner mother particle can be mixed with the toner, followed by applying a heat so that the materials are embedded to the surface of the toner particles. Thereby, small concavity and convexity can be formed on the surface of the toner particles.

<External Additive>

Specific examples of external additives for use in the toner of the present invention include inorganic particles and surface-treated inorganic particles. These can be used alone or in combination. The surface-treated inorganic particle preferably has a primary average particle diameter of 1 to 100 nm, and more preferably 5 to 70 nm. The specific surface area determined by the BET method is preferably 20 to 500 m²/g. Any known materials can be used such as hydrophobized silica, fatty acid metal salts (such as zinc stearate and aluminum stearate), metal oxides (such as titania, alumina, tin oxide and antimony oxide) and fluoropolymers.

In particular, suitable external additives for use in the toner of the present invention include hydrophobized silica, titania, titanium oxide, alumina. Specific examples of the marketed products of the silica include HDK H 2000, HDK H 2000/4, HDK H 2050EP, HVK21 and HDK H 1303 (from Clariant Japan Ltd.); R972, R974, RX200, RY200, R202, R805and R812 (from Nippon Aerosil Co., Ltd.); etc. Specific examples of the marketed products of the titania include P-25 (from Nippon Aerosil Co., Ltd.); STT-30and STT-65C-S (from Titan Kogyo Kabushiki Kaisha); TAF-140 (from Fuji Titanium Industry Co., Ltd.); MT-150W, MT-500B, MT-600B and MT-150A (from Tayca Corporation); etc. Specific examples of the marketed products of hydrophobic titanium oxide include T-805 (from Nippon Aerosil Co., Ltd.); STT-30A and STT-65S-S (from Titan Kogyo Kabushiki Kaisha); TAF-500T and TAF-1500T (from Fuji Titanium Industry Co., Ltd.); MT-100S and MT-100T (from Tayca Corporation); IT-S (from Ishihara Sangyo Kaisha Ltd.); etc.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Preparation of Mother Toner Particles (A) by Dry-Pulverization Method

The following components were mixed with an FM MIXER (manufactured by Mitsui Mining Co., Ltd.).

| | | |
|---|---|---|
| Polyester resin 1 | 70 | parts |
| (Mw of 21000, Mn of 4200, Tg of 72° C.) | | |
| Polyester resin 2 | 30 | parts |
| (Mw of 210000, Mn of 3600, Tg of 74° C.) | | |
| Carbon black | 8 | parts |
| Charge controlling agent | 1 | part |
| (BONTRON E-84 from Orient Chemical Industries, Ltd.) | | |
| Carnauba wax | 3 | parts |

The mixture was kneaded with a two-roll mill (manufactured by Toshiba Machine Co., Ltd.), followed by coarse pulverization with a pulverizer and fine pulverization with a counter jet mill (manufactured by Hosokawa Micron Corporation). Then the pulverized particles are classified by a high accuracy airflow classifier (manufactured by Nippon Pneumatic Mfg. Co., Ltd.). Thus, mother toner particles (A) having a weight average particle diameter (Dv) of 6.8 μm were prepared.

Preparation of Mother Toner Particles (B) by Dry-Pulverization Method

The following components were mixed with an FM MIXER (manufactured by Mitsui Mining Co., Ltd.).

| | | |
|---|---|---|
| Polyester resin 3 | 100 | parts |
| (Mw of 17000, Mn of 3500, Tg of 59° C.) | | |
| Carbon black | 6 | parts |
| Charge controlling agent | 1 | part |
| (BONTRON S-34 from Orient Chemical Industries, Ltd.) | | |
| Polypropylene wax | 6 | parts |

The mixture was kneaded with a two-roll mill (manufactured by Toshiba Machine Co., Ltd.), followed by coarse pulverization with a pulverizer and fine pulverization with a counter jet mill (manufactured by Hosokawa Micron Corporation). Then the pulverized particles are classified by a high accuracy airflow classifier (manufactured by Nippon Pneumatic Mfg. Co., Ltd.). Thus, mother toner particles (B) having a weight average particle diameter (Dv) of 8.5 μm were prepared.

Preparation of Mother Toner Particles (C) by Wet-Polymerization Method

Preparation of Particulate Resin

In a reaction vessel equipped with a stirrer and a thermometer, 683 parts of water, 11 parts of a sodium salt of sulfate of an ethylene oxide adduct of methacrylic acid (ELEMINOL RS-30 from Sanyo Chemical Industries Ltd.), 83 parts of styrene, 83 parts of methacrylic acid, 110 parts of butyl acrylate and 1 part of ammonium persulfate were contained and the mixture was agitated with the stirrer for 15 minutes at a revolution of 400 rpm. As a result, a milky emulsion was prepared. Then the emulsion was heated to 75° C. to react the monomers for 5 hours.

Further, 30 parts of a 1% aqueous solution of ammonium persulfate were added thereto, and the mixture was aged for 5 hours at 75° C. Thus, an aqueous dispersion (i.e., particle dispersion (1)) of a vinyl resin (i.e., a copolymer of styrene/methacrylic acid/butyl acrylate/sodium salt of sulfate of ethylene oxide adduct of methacrylic acid) was prepared.

The particulate vinyl resin had a volume average particle diameter of 0.10 μm determined by a laser diffraction and scattering type particle size distribution analyzer LA-920 (manufactured by Horiba Ltd.). A portion of the particle dispersion (1) was dried and isolated the resin constitution. The resin had a glass transition temperature (Tg) of 57° C.

Preparation of Water Phase

990 parts of water, 80 parts of the particle dispersion (1) prepared above, 40 parts of an aqueous solution of a sodium salt of dodecyldiphenyletherdisulfonic acid (ELEMINOL MON-7 (trademark) from Sanyo Chemical Industries Ltd., solid content of 48.5%), and 90parts of ethyl acetate were mixed. As a result, a water phase (1) was prepared.

Preparation of Low Molecular Weight Polyester

The following components were fed in a reaction vessel equipped with a condenser, a stirrer and a nitrogen feed pipe.

| | | |
|---|---|---|
| Ethylene oxide (2 mole) adduct of | 220 | parts |
| bisphenol A | | |
| Propylene oxide (3 mole) adduct of | 561 | parts |
| bisphenol A | | |
| Terephthalic acid | 218 | parts |
| Adipic acid | 48 | parts |
| Dibutyltin oxide | 2 | parts |

The mixture was reacted for 8 hours at 230° C. under normal pressure.

Then the reaction was further continued for 5 hours under a reduced pressure of 10 to 15 mmHg.

Further, 45 parts of trimellitic anhydride was fed to the container to be reacted with the reaction product for 2 hours at 180° C. Thus, a low molecular weight polyester (1) was prepared. The low molecular weight polyester (1) had a number average molecular weight (Mn) of 2500, a weight average molecular weight (Mw) of 6700, a glass transition temperature (Tg) of 47° C., and acid value of 25 mgKOH/g.

Preparation of Prepolymer

The following components were fed in a reaction vessel equipped with a condenser, a stirrer and a nitrogen feed pipe.

| | | |
|---|---|---|
| Ethylene oxide (2 mole) adduct of | 682 | parts |
| bisphenol A | | |
| Propylene oxide (2 mole) adduct of | 81 | parts |
| bisphenol A | | |
| Terephthalic acid | 283 | parts |
| Trimellitic anhydride | 22 | parts |
| Dibutyl tin oxide | 2 | parts |

The mixture was reacted for 8 hours at 230° C. under normal pressure.

Then the reaction was further continued for 5 hours under a reduced pressure of 10 to 15 mmHg. Thus, an intermediate polyester resin (1) was prepared. The intermediate polyester (1) had a number average molecular weight (Mn) of 2,100, a weight average molecular weight (Mw) of 9,500, a glass transition temperature (Tg) of 55° C., an acid value of 0.5 mgKOH/g and a hydroxyl value of 49 mgKOH/g.

In a reaction vessel equipped with a condenser, a stirrer and a nitrogen feed pipe, 411 parts of the intermediate polyester resin (1), 89 parts of isophorone diisocyanate and 500 parts of ethyl acetate were mixed and the mixture was heated at 100° C. for 5 hours to perform the reaction. Thus, a polyester prepolymer (1) having an isocyanate group was prepared. A content of free isocyanate in the prepolymer (1) was 1.53% by weight.

Synthesis of Ketimine Compound

In a reaction vessel equipped with a stirrer and a thermometer, 170 parts of isophorone diamine and 75 parts of methyl ethyl ketone were mixed and reacted for 5 hours at 50° C. to prepare a ketimine compound (1). The ketimine compound (1) had an amine value of 418 mgKOH/g.

Preparation of Masterbatch (1)

The following components were mixed with a HENSHEL MIXER.

| | | |
|---|---|---|
| Carbon black | 40 | parts |
| (REGAL 400R from Cabot Corp.) | | |
| Polyester resin | 60 | parts |
| (RS-801 from Sanyo Chemical Industries Ltd., having an | | |
| acid value of 10 mgKOH/g, Mw of 20000, and Tg of 64° C.) | | |
| Water | 30 | parts |

The mixture was kneaded with a two-roll mill for 45 minutes at 130° C., then pulverized into particles having a particle diameter of 1 mm using a pulverizer. Thus, a masterbatch (1) was prepared.

Preparation of Oil Phase Liquid

In a reaction vessel equipped with a stirrer and a thermometer, 378 parts of the low molecular weight polyester (1), 110 parts of a carnauba wax, and 947 parts of ethyl acetate were mixed and the mixture was heated to 80° C. while agitated. After being heated at 80° C. for 5 hours, the mixture was cooled to 30° C. over 1 hour. Then 500 parts of the masterbatch (1) and 500 parts of ethyl acetate were added to the vessel, and the mixture was agitated for 1 hour to prepare a raw material dispersion (1).

Then 1324 parts of the raw material dispersion (1) were subjected to a dispersion treatment using a bead mill (ULTRAVISCOMILL (trademark) from Aimex Co., Ltd.). The dispersing conditions were as follows.
Liquid feeding speed: 1 kg/hour
Peripheral speed of disc: 6 m/sec
Dispersion media: zirconia beads with a diameter of 0.5 mm
Filling factor of beads: 80% by volume
Repeat number of dispersing operation: 3 times (3 passes)

Then 1324 parts of a 65% ethyl acetate solution of the low molecular weight polyester (1) prepared above was added thereto. The mixture was subjected to the dispersion treatment using the bead mill. The dispersion conditions are the same as those mentioned above except that the dispersion operation was performed once (i.e., one pass).

Thus, a colorant/wax dispersion (1) was prepared. A solid content of the colorant/wax dispersion (1) was 50% at 130° C., 30 minutes.

Emulsification

Then the following components were mixed in a vessel.

| | | |
|---|---|---|
| Colorant/wax dispersion (1) prepared above | 648 | parts |
| Prepolymer (1) prepared above | 154 | parts |
| Ketimine compound (1) prepared above | 6.6 | parts |

The components were mixed for 1 minute using a mixer TK HOMOMIXER (trademark) from Tokushu Kika Kogyo K. K. at a revolution of 5,000 rpm. Thus, an oil phase liquid (1) was prepared.

Then 1200 parts of the water phase (1) prepared above was added thereto. The mixture was agitated for 20 minutes with a mixer TK HOMOMIXER (trademark) at a revolution of 13,000 rpm. As a result, an emulsion (1) was prepared.

Shape Control

1365 parts of ion exchanged water and 35 parts of carboxymethylcellulose (CMC DAICEL-128 from Daicel Chemical Industries Ltd.) were mixed, then 1000 parts of the emulsion (1) was added. The mixture was agitated for 1 hour with a mixer TK HOMOMIXER (trademark) at a revolution of 2,000 rpm. As a result, a shape-controlled emulsion (1) was prepared.

Solvent Removal

The shape-controlled emulsion (1) was fed into a container equipped with a stirrer and a thermometer, and the emulsion was heated for 8 hours at 30° C. to remove the organic solvent (ethyl acetate) from the emulsion. Then the emulsion was aged for 4 minutes at 45° C. Thus, a dispersion (1) was prepared.

Washing and Drying

One hundred (100) parts of the dispersion (1) was filtered under a reduced pressure.

The thus obtained wet cake was mixed with 100 parts of ion-exchange water and the mixture was agitated for 10 minutes with a TK HOMOMIXER at a revolution of 12,000 rpm, followed by filtering. Thus, a wet cake (1) was prepared.

The wet cake (1) was mixed with 100 parts of a 10% aqueous solution of sodium hydroxide and the mixture was agitated for 30 minutes with a TK HOMOMIXER at a revolution of 12,000 rpm with applying an ultrasonic wave, followed by filtering under a reduced pressure. This ultrasonic alkaline washing operation was performed twice. Thus, a wet cake (2) was prepared.

The wet cake (2) was mixed with 100 parts of a 10% aqueous solution of hydrochloric acid and the mixture was agitated for 10 minutes with a TK HOMOMIXER at a revolution of 12,000 rpm, followed by filtering. Thus, a wet cake (3) was prepared.

The wet cake (3) was mixed with 300 parts of ion-exchange water and the mixture was agitated for 10 minutes with a TK HOMOMIXER at a revolution of 12,000 rpm, followed by filtering. This washing operation was performed twice. Thus, a wet cake (4) was prepared.

The wet cake (4) was dried for 48 hours at 45° C. using a circulating air drier, followed by sieving with a screen having openings of 75 μm. Thus, polymerization mother toner particles (C) having a weight average particle diameter of 5.6 μm were prepared.

Preparation of Mother Toner Particles (D) by Wet-Polymerization Method

The procedure for preparation of the mother toner particles (C) was repeated except the following conditions were changed as appropriate:
(1) a revolution and an agitating time of TK HOMOMIXER in the emulsification process;
(2) a content of viscosity improver, and a revolution and an agitating time of TK HOMOMIXER in the shape control process; and
(3) an operation temperature and time in the solvent removal process.

Thus, mother toner particles (D) having a weight average particle diameter of 7.5 μm were prepared.

Preparation of Mother Toner Particles (E) by Wet-Polymerization Method

The procedure for preparation of the mother toner particles (C) was repeated except the following conditions were changed as appropriate:
(1) a revolution and an agitating time of TK HOMOMIXER in the emulsification process;
(2) a content of viscosity improver, and a revolution and an agitating time of TK HOMOMIXER in the shape control process; and
(3) an operation temperature and time in the solvent removal process.

Thus, mother toner particles (E) having a weight average particle diameter of 9.2 μm were prepared.

### Example 1

One hundred (100) parts of the mother toner particles (A) were mixed with 2.0 parts of an external additive (H2000 from Clariant Japan Ltd.) using an FM MIXER (manufactured by Mitsui Mining Co., Ltd.), followed by sieving with a screen having openings of 32 μm.

The fluidity of the toner was evaluated by measuring a torque when the intrusion distance of the cone rotor was 20 mm from the surface of the toner layer. The toner was contained in a cylinder container having a diameter of 60 mm and height of 50 mm. The toner was compressed to be a consolidation state. The void ratio was measured before the measure of the torque. The consolidation pressures were 500, 1000 and 3000 N/m².

### Example 2

One hundred (100) parts of the mother toner particles (B) were mixed with 1.0 part of an external additive (H2000 from Clariant Japan Ltd.) using an FM MIXER (manufactured by Mitsui Mining Co., Ltd.), followed by sieving with a screen having openings of 32 μm.

The methods of measuring the void ratio and the torque are the same as Example 1.

### Example 3

One hundred (100) parts of the mother toner particles (C) were mixed with 2.0 parts of an external additive (H2000 from Clariant Japan Ltd.) using an FM MIXER (manufactured by Mitsui Mining Co., Ltd.), followed by sieving with a screen having openings of 32 μm.

The methods of measuring the void ratio and the torque are the same as Example 1.

### Example 4

One hundred (100) parts of the mother toner particles (D) were mixed with 2.0 parts of an external additive (H2000 from Clariant Japan Ltd.) using an FM MIXER (manufactured by Mitsui Mining Co., Ltd.), followed by sieving with a screen having openings of 32 μm.

The methods of measuring the void ratio and the torque are the same as Example 1.

### Example 5

One hundred (100) parts of the mother toner particles (E) were mixed with 2.0 parts of an external additive (H2000 from Clariant Japan Ltd.) using an FM MIXER (manufactured by Mitsui Mining Co., Ltd.), followed by sieving with a screen having openings of 32 μm.

The methods of measuring the void ratio and the torque are the same as Example 1.

### Comparative Example 1

One hundred (100) parts of the mother toner particles (A) were mixed with 1.0 part of an external additive (R972D from Nippon Aerosil Co., Ltd.) using an FM MIXER (manufactured by Mitsui Mining Co., Ltd.), followed by sieving with a screen having openings of 32 μm.

The methods of measuring the void ratio and the torque are the same as Example 1.

### Comparative Example 2

One hundred (100) parts of the mother toner particles (A) were used without any external additives.

The methods of measuring the void ratio and the torque are the same as Example 1.

The properties of each of the thus prepared toners are shown in Table 1.

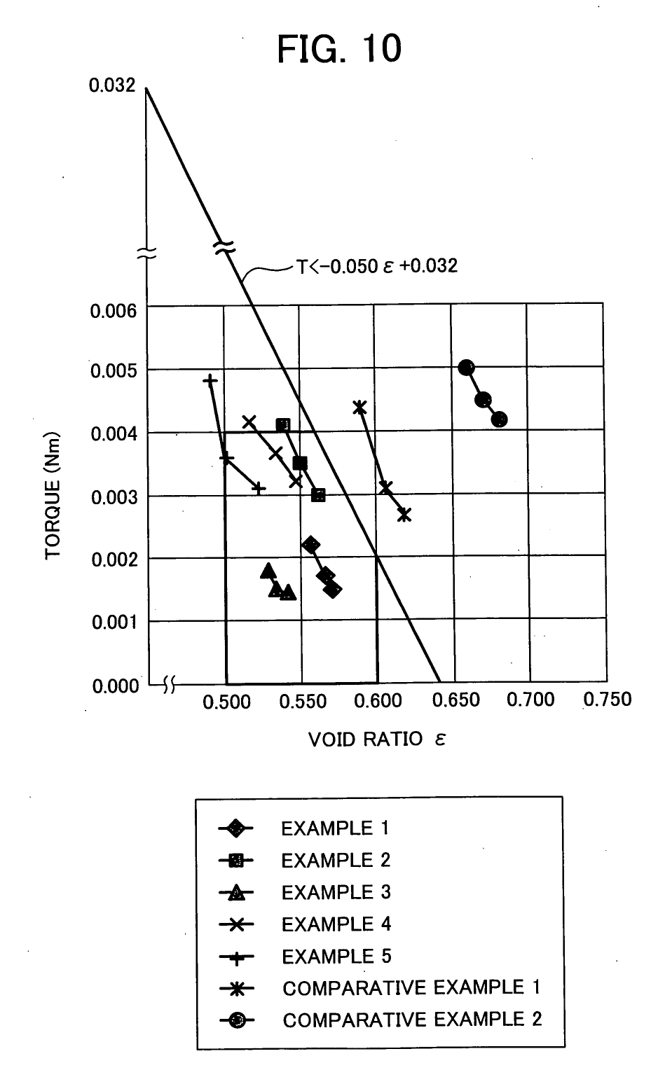

The results of the evaluations are shown in Table 2 and FIG. 10.

TABLE 1

| | Manufacturing | | | Average | | |
|---|---|---|---|---|---|---|
| Toner | method | Dv | Dv/Dn | Circularity | SF-1 | SF-2 |
| A | Pulverization | 6.8 | 1.21 | 0.92 | 142 | 153 |
| B | Pulverization | 8.5 | 1.26 | 0.91 | 149 | 163 |
| C | Polymerization | 5.6 | 1.16 | 0.97 | 115 | 116 |
| D | Polymerization | 7.5 | 1.32 | 0.95 | 131 | 135 |
| E | Polymerization | 9.2 | 1.19 | 0.96 | 120 | 121 |

TABLE 2

| | | | Consolidation | | Consolidation | | Consolidation | | | |
|---|---|---|---|---|---|---|---|---|---|---|
| | | | pressure of 500 N/m² | | pressure of 1000 N/m² | | pressure of 3000 N/m² | | | Amount of |
| | | External | Void | Torque | Void | Torque | Void | Torque | Toner | remaining |
| | Toner | Additive | ratio | (×10⁻³ Nm) | ratio | (×10⁻³ Nm) | ratio | (×10⁻³ Nm) | ejectability | toner (g) |
| Ex.1 | A | H2000 | 0.570 | 1.56 | 0.567 | 1.70 | 0.557 | 2.23 | ⊚ | 5 |
| | | 2 parts | | | | | | | | |
| Ex. 2 | B | H2000 | 0.562 | 3.02 | 0.551 | 3.51 | 0.538 | 4.13 | ◯ | 13 |
| | | 1 part | | | | | | | | |
| Ex. 3 | C | H2000 | 0.543 | 1.47 | 0.535 | 1.51 | 0.526 | 1.89 | ⊚ | 7 |
| | | 2 parts | | | | | | | | |
| Ex. 4 | D | H2000 | 0.545 | 3.25 | 0.533 | 3.70 | 0.516 | 4.20 | ◯ | 21 |
| | | 2 parts | | | | | | | | |
| Ex. 5 | E | H2000 | 0.523 | 3.11 | 0.502 | 3.58 | 0.491 | 4.81 | ◯ | 51 |
| | | 2 parts | | | | | | | | |
| Comp. | A | R972D | 0.619 | 2.74 | 0.607 | 3.14 | 0.589 | 4.42 | X | 450 |
| Ex. 1 | | 1 part | | | | | | | | |
| Comp. | A | none | 0.682 | 4.20 | 0.671 | 4.51 | 0.661 | 5.01 | XX | 500 |
| Ex. 2 | | | | | | | | | | |

The toner ejectability is graded as follows:
⊚: The toner was ejected stably. In addition, the pump operation time (from 0.1 to 1.0 seconds) was nearly proportional to the amount of the ejecting toner.
◯: The toner was ejected stably.
Δ: The toner ejection was sometimes stopped.
X: The toner ejection was stopped at a certain point.
XX: The toner was not ejected.

The amount of remaining toner was determined as the difference between the initial weight of the toner container filled with a toner of 500 g and the weight of the toner container after the toner ejection evaluation was performed.

It is clear from Table 2 that the toner ejectability and the amount of remaining toner of the present invention have a strong correlation with the void ratio and the torque. The toners used in examples 1 to 5 have small void ratio and torque, and have good toner ejectability while the amount of remaining toner is relatively small compared to the toners of comparative examples.

It is clear from FIG. 10 that the toners having good ejectability and less toner remaining amount satisfy the following formula (1):
T<−0.05ε+0.032 (1)
wherein ε represents the void ratio of the bulk toner formed by consolidating the toner with a load of 500 to 3000 N/m² , and T represents the torque (Nm) needed for intruding the cone rotor having a vertical angle of 60°, an edge length of 30 mm, and ditches which gradually deepen from vertex to base, into the bulk toner at a speed of 5 mm/min while rotating the cone rotor, wherein the torque is measured when the cone rotor is intruded into the bulk toner at a length of 20 mm.

It is also clear from FIG. 10 that the toners having a void ratio ε of 0.5 to 0.6 and a torque T of not greater than 0.004 Nm show much better ejectability and much less remaining toner content.

This application claims priority and contains subject matter related to Japanese Patent Application No. 2005-016440, filed on Jan. 25, 2005, the entire contents of which are hereby incorporated by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A toner comprising binder resin and colorant, wherein the toner satisfies the following relationship (1):
T<−0.05ε+0.032 (1)
wherein ε represents a void ratio of a bulk toner formed by consolidating the toner with a load of 500 to 3000 N/M², and T represents a torque (Nm) needed for intruding a cone rotor having a vertical angle of 60°, an edge length of 30 mm, and ditches which gradually deepen from vertex to base, into the bulk toner at a speed of 5 mm/min while rotating the cone rotor, wherein the torque is measured when the cone rotor is intruded into the bulk toner at a length of 20 mm.

2. The toner according to claim 1, wherein the toner has a void ratio of 0.5 to 0.6 when the toner is consolidated by a load of 500 to 3000 N/m².

3. The toner according to claim 1, wherein the torque T is not greater than 0.0004 Nm.

4. The toner according to claim 1, wherein the toner has an average circularity of not less than 0.90.

5. The toner according to claim 1, wherein the toner has a volume average particle diameter (Dv) of 3 to 8 μm and a ratio (Dv/Dn) of the volume average particle diameter (Dv) to a number average particle diameter (Dn) of 1.00 to 1.40.

6. The toner according to claim 1, wherein the toner has shape factors SF-1 of 100 to 180 and SF-2 of 100 to 180.

7. The toner according to claim 1, wherein the toner is manufactured by a dry-pulverization method comprising:
kneading a toner composition comprising the binder resin and the colorant;
pulverizing the kneaded toner composition; and
classifying the pulverized toner composition.

8. The toner according to claim 1, wherein the toner is manufactured by a wet-polymerization method comprising:
dissolving or dispersing a toner constituent mixture comprising a polymer capable of reacting with an active hydrogen atom, a polyester resin, and the colorant, in an organic solvent to prepare a toner constituent mixture liquid; and
dispersing the toner constituent mixture liquid in an aqueous medium while subjecting the polymer to at least one of an extension reaction or a crosslinking reaction using a compound having an active hydrogen atom, to prepare a dispersion comprising toner particles in the presence of a particulate resin.

9. The toner according to claim 1, further comprising a release agent.

10. A toner container comprising a flexible member containing the toner according to claim 1, and an adopter by which the toner container is set to an image forming apparatus, wherein the toner container reduces volume as the toner is discharged therefrom.

11. A toner feeding device comprising;
the toner container according to claim 10; and
a toner feeding member configured to transport the toner from the toner container to an image forming apparatus.

12. The toner feeding device according to claim 11, wherein the toner has a void ratio of 0.5 to 0.6 when the toner is consolidated by a load of 500 to 3000 N/m².

13. The toner feeding device according to claim 11, wherein the torque T is not greater than 0.0004 Nm.

14. The toner feeding device according to claim 11, wherein the flexible member of the toner feeding container comprises a resin film, and the volume of the toner container is reduced by not less than 60%.

15. The toner feeding device according to claim 11, wherein the toner feeding member comprises a pump configured to feed the toner.

16. The toner feeding device according to claim 15, wherein the pump is a mohno pump.

17. An image forming apparatus comprising:
an image bearing member configured to bear an electrostatic latent image;
a charging device configured to charge the image bearing member;
a writing device configured to irradiate the charged image bearing member with a light beam to form the electrostatic latent image;
a developing device configured to develop the electrostatic latent image with a developer comprising a toner to form a toner image on the image bearing member;
the toner container according to claim 10; and
a toner feeding device configured to feed the toner from the toner container to the developing device.
